(19) United States
(12) Patent Application Publication
(10) Pub. No.: US 2025/0042461 A1
(43) Pub. Date: Feb. 6, 2025

(54) AUXILIARY MECHANISM FOR ASSISTING FOLDING OR UNFOLDING FRAME OF PUSHCART AND PUSHCART

(71) Applicant: WONDERLAND SWITZERLAND AG, Steinhausen (CH)

(72) Inventors: Xiaolong YI, Dongguan, Guangdong (CN); Liwu FANG, Dongguan, Guangdong (CN)

(21) Appl. No.: 18/720,179

(22) PCT Filed: Jan. 13, 2023
(86) PCT No.: PCT/EP2023/050771

§ 371 Date: Jun. 14, 2024

(30) Foreign Application Priority Data
Jan. 13, 2022 (CN) 202210035517.9

(51) Int. Cl. B62B 7/06

(52) U.S. Cl. CPC B62B 7/066

(57) ABSTRACT

The disclosure provides an auxiliary mechanism for assisting folding or unfolding a frame of a pushcart as well as a pushcart. The frame includes a first rod and a second rod being pivotable relative to each other. When the first rod and the second rod are relatively pivoted to a first position, the frame is in an unfolded state; and when the first rod and the second rod are relatively pivoted to a second position, the frame is in a folded state, wherein the auxiliary mechanism includes an elastic member, the elastic member drives the first rod and the second rod to be relatively pivoted towards the first position or towards the second position. The auxiliary mechanism according to the disclosure facilitates the user to unfold or fold the frame more easily, and enables the frame to be unfolded or folded in place, thus avoiding potential safety hazards.

### CROSS-REFERENCE TO RELATED APPLICATIONS

This application is a National Stage application of PCT/EP2023/050771, entitled “AUXILIARY MECHANISM FOR ASSISTING FOLDING OR UNFOLDING FRAME OF PUSHCART AND PUSHCART” and filed on Jan. 13, 2023, which claims the benefit of Chinese Application No. 202210035517.9, filed on Jan. 13, 2022, both of which are incorporated herein by reference in their entirety.

### TECHNICAL FIELD

The present disclosure relates to a pushcart, and more particularly, to an auxiliary mechanism for assisting folding or unfolding a frame of the pushcart.

### BACKGROUND

The pushcart related herein may a stroller for carrying children or a cart for carrying articles. Generally, a frame of the pushcart can be converted between a folded state and an unfolded state, such that the pushcart can be conveniently transported and stored when not in use.

### SUMMARY

The purpose of the disclosure is to provide an auxiliary mechanism for assisting folding or unfolding a frame of a pushcart, which not only facilitates the user to unfold or fold the frame more easily, but also enables the frame to be unfolded or folded in place, thus avoiding potential safety hazards.

As embodied and generally described here, in order to achieve these and other advantages and according to the purpose of the disclosure, an auxiliary mechanism for assisting folding or unfolding a frame of a pushcart is proposed. The frame includes a first rod and a second rod being pivotable relative to each other, when the first rod and the second rod are relatively pivoted to a first position, the frame is in an unfolded state; and when the first rod and the second rod are relatively pivoted to a second position, the frame is in a folded state, wherein the auxiliary mechanism includes an elastic member, and the elastic member drives the first rod and the second rod to be relatively pivoted towards the first position or towards the second position.

In an embodiment, the first rod is a support frame of the frame, and the second rod is an upper handle frame of the frame, an end of the support frame is hinged to the upper handle frame, the elastic member is a tension spring, one end of the tension spring is connected to the support frame, and the other end of the tension spring is connected to the upper handle frame, such that when the support frame and the upper handle frame are relatively pivoted to the first position or the second position, a stretched length of the tension spring is smaller than a maximum length of the tension spring being stretched when the support frame and the upper handle frame are relatively pivoted.

In an embodiment, an end of the first rod and an end of the second rod are coupled by a connecting shaft, so that the first rod and the second rod are rotatable with respect to each other around the connecting shaft.

In an embodiment, the first rod is a lower handle frame of the frame, and the second rod is an upper handle frame of the frame, and the auxiliary mechanism further includes: an inclined chute in an annular shape, located at a first coupling end face of an upper end of the lower handle frame and around the connecting shaft, and the inclined chute being inclined along a rotation direction and has a highest point; a driving block, disposed on a second coupling end face of a lower end of the upper handle frame, the driving block being able to extend out of or retract from the second coupling end face, and a top end of the driving block slides while abutting against the inclined chute; and the elastic member is a compression spring disposed inside a lower end of the upper handle frame, the compression spring acts on a bottom end of the driving block, so as to drive the driving block to extend out of the second coupling end face and press against the inclined chute, and the driving block slides along the inclined chute, so as to bring the lower end of the upper handle frame to rotate with respect to the upper end of the lower handle frame.

In an embodiment, the inclined chute is provided with a blocking portion to block the driving block at the blocking portion, such that the lower end of the upper handle frame is able to rotate within a certain angle in one direction with respect to the upper end of the lower handle frame.

In an embodiment, the first rod is a lower handle frame of the frame, and the second rod is an upper handle frame of the frame, the elastic member is a torsion spring arranged around the connecting shaft, one end of the torsion spring is connected to a lower end of the upper handle frame, and the other end of the torsion spring is connected to an upper end of the lower handle frame, so that the torsion spring is able to drive the lower end of the upper handle frame and the upper end of the lower handle frame to rotate with respect to each other, and the upper handle frame and the lower handle frame are relatively pivoted towards one of the first position or the second position.

In an embodiment, the first rod is a lower handle frame of the frame, the second rod is a front wheel bracket of the frame, and the elastic member is a torsion spring arranged around the connecting shaft, a coupling end face of a lower end of the lower handle frame is fixed to a first sheet member, and the coupling end face of an upper end of the front wheel bracket is fixed to a second sheet member, one end of the torsion spring is connected to the first sheet member, and the other end of the torsion spring is connected to the second sheet member, so that the torsion spring is able to drive the lower end of the lower handle frame and the upper end of the front wheel bracket to rotate with respect to each other, and the lower handle frame and the front wheel bracket are relatively pivoted towards one of the first position or the second position.

In an embodiment, an upper end of the rear wheel bracket of the frame is coupled to the lower end of the lower handle frame and the upper end of the front wheel bracket by the connecting shaft, such that the lower handle frame and the front wheel bracket are able to be pivoted with respect to the rear wheel bracket.

In an embodiment, the first sheet member is provided with a first bending slot penetrating the first sheet member and extending around the connecting shaft, and the second sheet member is provided with a second bending slot penetrating the second sheet member and extending around the connecting shaft, wherein the second bending slot and the first bending slot have corresponding radial positions with respect to the connecting shaft, and the first bending slot and the second bending slot are arranged to have overlapping portions, the upper end of the rear wheel bracket is fixed with a linkage gear, and the linkage gear is arranged to penetrate into the overlapping portions; wherein each of the first bending slot and the second bending slot has a rack structure engaged with the linkage gear, when the first bending slot of the first sheet member rotates around the connecting shaft, the rack structure of the first bending slot drives the linkage gear, and the linkage gear drives the second bending slot of the second sheet member to rotate reversely around the connecting shaft via the rack structure of the second bending slot, such that the first sheet member and the second sheet member rotate synchronously and reversely around the connecting shaft.

In another aspect, the disclosure provides a pushcart, comprising a frame and the auxiliary mechanism as mentioned above, wherein the frame is assisted to be fold or unfold by the auxiliary mechanism.

One of the beneficial effects of the disclosure is that the auxiliary mechanism for assisting folding or unfolding the frame of the pushcart according to the disclosure may not only facilitate the user to unfold or fold the frame more easily, but also enables the frame to be unfolded or folded in place, thus avoiding potential safety hazards.

The foregoing and other purposes, features, aspects and advantages of the disclosure will become more apparent from the following detailed description of the disclosure in conjunction with the accompanying drawings.

### BRIEF DESCRIPTION OF THE DRAWINGS

The accompanying drawings are included here to provide a further understanding of the present disclosure, and are incorporated into and constitute a part of this specification. The accompanying drawings illustrate embodiments of the disclosure, and together with the following description, serve to explain the concept of the disclosure.

In the attached drawings:

FIG. 1 is an overall perspective and partial enlarged view of a frame of a pushcart with an auxiliary mechanism according to a first embodiment of the disclosure, showing the frame in an unfolded state.

FIG. 2 is an overall perspective and partial enlarged view of the frame of the pushcart shown in FIG. 1, showing the frame in a semi-folded state.

FIG. 3 is an overall perspective and partial enlarged view of the frame of the pushcart shown in FIG. 1, showing the frame in a folded state.

FIG. 4 is a perspective view of a frame of a pushcart with an auxiliary mechanism according to a second embodiment of the disclosure.

FIG. 5 is a partial sectional view taken along the line I-I in FIG. 4.

FIG. 6 is a perspective view of an upper end of a lower handle frame in FIG. 5.

FIG. 7 is a perspective view of a lower end of an upper handle frame in FIG. 5.

FIG. 8 is a schematic view of the auxiliary mechanism according to the second embodiment of the disclosure when the frame is in an unfolded state.

FIG. 9 is a schematic view of the auxiliary mechanism according to the second embodiment of the disclosure when the frame is in a semi-folded state.

FIG. 10 is a schematic view of the auxiliary mechanism according to the second embodiment of the disclosure when the frame is in a folded state.

FIG. 11 is a perspective view of the frame of the pushcart with the auxiliary mechanism according to a third and fourth embodiments of the disclosure.

FIG. 12 is an enlarged view of part A1 of the frame of FIG. 11 with the auxiliary mechanism according to the third embodiment of the disclosure.

FIG. 13 is a perspective view of the upper end of the lower handle frame in FIG. 12.

FIG. 14 is a perspective view of the lower end of the upper handle frame in FIG. 12.

FIG. 15 is an enlarged view part A2 of the frame of FIG. 11 with the auxiliary mechanism according to the fourth embodiment of the disclosure.

FIG. 16 is a schematic view of the auxiliary mechanism according to the fourth embodiment of the disclosure when the frame is in the unfolded state.

FIG. 17 is a schematic view of the auxiliary mechanism according to the fourth embodiment of the disclosure when the frame is in the folded state.

### DETAILED DESCRIPTION

When a general frame is folded and unfolded, the user may need to apply a relative great force to finish it, which is not really friendly for users with weak physical strength. In addition, the frame may be not folded or unfolded properly, which will bring potential safety hazards to the users.

Hereinafter, exemplary embodiments of the disclosure will be described in detail with reference to the accompanying drawings. Although the disclosure is susceptible to various forms of modifications and substitutions, its specific embodiments are shown by way of example in the attached drawings. However, this disclosure should not be construed as being limited to the embodiments set forth herein, but on the contrary, the disclosure will cover all modifications, equivalents and alternatives that fall within the spirit and scope of the embodiments.

In a frame 1 of a pushcart, there are a plurality of connecting rods, which can include, for example, a support frame 100, an upper handle frame 200, a lower handle frame 300, a front wheel bracket 400, a rear wheel bracket 500, and so on. The connecting rods are involved in the disclosure for convenience of description, but the disclosure is not limited to these connecting rods.

Various connecting rods are connected to each other, so as to form different parts of the frame 1. Meanwhile, in order to facilitate transportation and storage, the frame 1 can usually be converted between a folded state and an unfolded state. Therefore, at least parts of the connecting rods of the frame 1 are pivotably connected to each other, such that folding and unfolding of the frame 1 can be realized through pivoting of the connecting rods with respect to each other. It should be noted that the auxiliary mechanism according to the disclosure for assisting folding or unfolding the frame 1 can be applied to any pair of the connecting rods that are pivotably connected to each other in the frame 1. For general description, in the disclosure, one of the pair of the connecting rods pivotably connected to each other is defined as a first rod, and the other is defined as a second rod. When the first rod and the second rod are pivoted to a first position relative to each other, the frame 1 is in an unfolded state. Moreover, when the first rod and the second rod are pivoted to a second position relative to each other, the frame 1 is in a folded state. The auxiliary mechanism according to the disclosure can facilitate the first rod and the second rod to be pivoted to the first or second position relative to each other. Specifically, the auxiliary mechanism includes an elastic member, and the elastic member drives the first rod and the second rod to be relatively pivoted towards the first position or the second position. On the other hand, under the action of the elastic member, the first rod and the second rod remain in the first position or the second position after being pivoted to the position, such that the frame 1 is kept at the unfolded state or the folded state. Therefore, the auxiliary mechanism according to the disclosure is not only beneficial for users to unfold or fold the frame 1, but also can assist unfolding or folding the frame 1 in place to avoid potential safety hazards.

Hereinafter, specific embodiments of the auxiliary mechanism according to the disclosure will be described in detail with reference to the accompanying drawings.

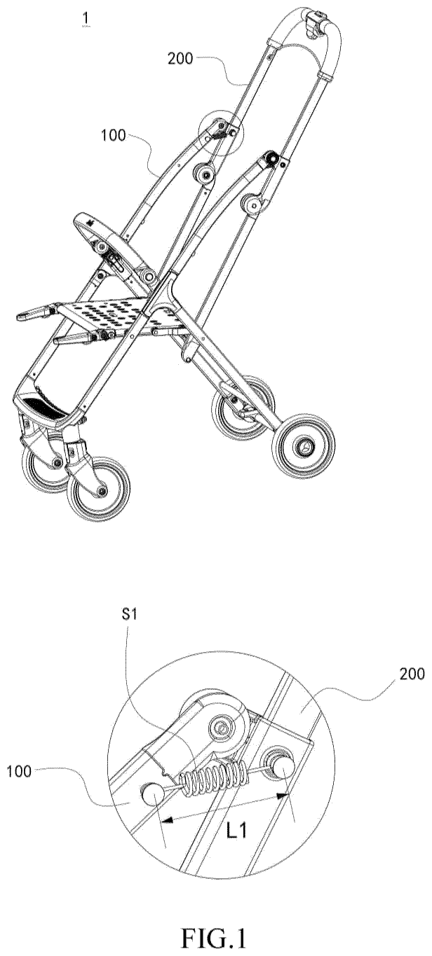

FIGS. 1 to 3 show the auxiliary mechanism according to a first embodiment of the disclosure.

As shown in FIGS. 1 to 3, the first rod is the support frame 100 of the frame 1, the second rod is the upper handle frame 200 of the frame 1, and an end of the support frame 100 is hinged to the upper handle frame 200, such that the support frame 100 and the upper handle frame 200 can be relatively pivoted. Among them, the support frame 100 can be used to connect the upper handle frame 200 to the front wheel bracket, as shown in FIG. 1. The upper handle frame 200 is used for the user to exert an acting force to the pushcart.

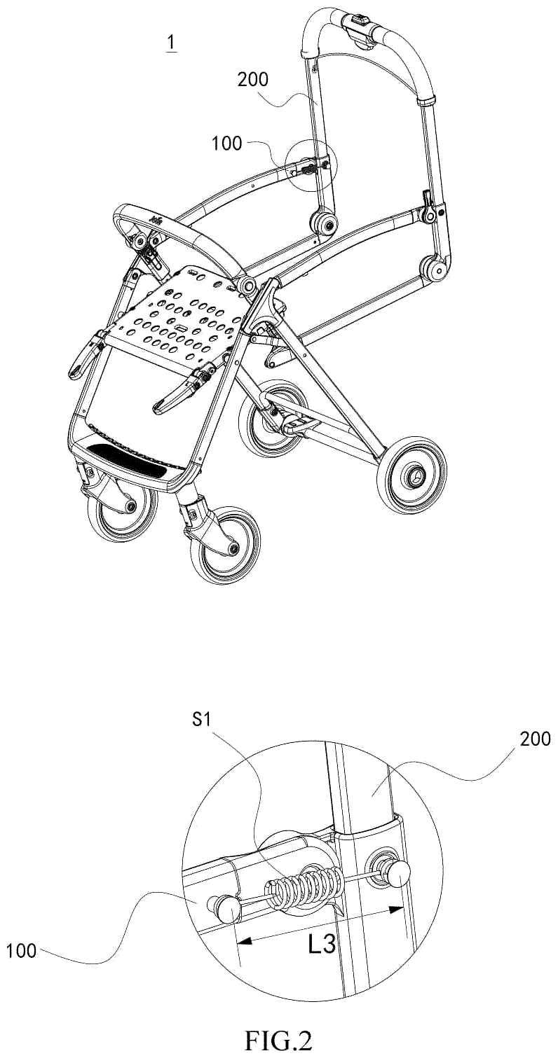

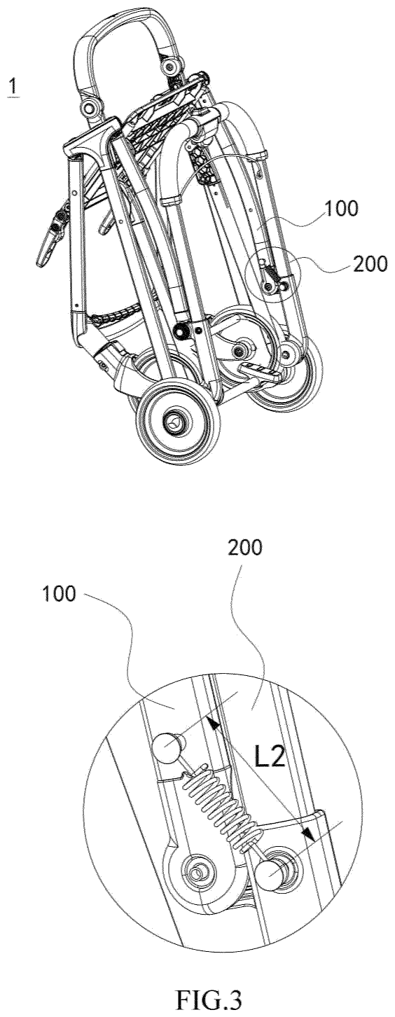

In the first embodiment, the elastic member is a tension spring S1, one end of which is connected to the support frame 100 and the other end of which is connected to the upper handle frame 200. In order to realize that the tension spring S1 can better drive the support frame 100 and the upper handle frame 200 to be relatively pivoted towards the first position or the second position, and the connection position of the tension spring S1 should be set such that a stretched length L1 of the tension spring S1 when the support frame 100 and the upper handle frame 200 are relatively pivoted to the first position (see FIG. 1) and a stretched length L2 of the tension spring S1 when the support frame 100 and the upper handle frame 200 are relatively pivoted to the second position (see FIG. 3) are both smaller than a maximum stretched length L3 of the tension spring S1 (see FIG. 2) when the support frame 100 and the upper handle frame 200 are relatively pivoted. Generally, when the pivot axis on which the support frame 100 and the upper handle frame 200 are relatively pivoted is on the same line as the two connecting ends of the tension spring S1, the tension spring S1 is stretched to a maximum length L3, as shown in FIG. 2.

In this way, when the user prepares to convert the frame 1 between the unfolded state and the folded state, an acting force exerted by the user on the frame 1 is required to overcome an elastic force of the tension spring S1, such that the support frame 100 and the upper handle frame 200 are relatively pivoted from one of the first position and the second position towards the other one. During this process, the tension spring S1 is stretched. After the tension spring S1 is stretched to the maximum length L3 and the support frame 100 and the upper handle frame 200 continue to be pivoted in the same direction, it is not necessary for the user to continue to exert the acting force on the frame 1, since the elastic force of the tension spring S1 drives the support frame 100 and the upper handle frame 200 to be relatively pivoted to another position and remain there.

Therefore, according to an arrangement of the auxiliary mechanism in the first embodiment of the disclosure, the tension spring S1 can drive the support frame 100 and the upper handle frame 200 to be relatively pivoted towards the first position, and can also drive both of the support frame 100 and the upper handle frame 200 to be relatively pivoted towards the second position.

FIGS. 4 to 10 show the auxiliary mechanism according to the second embodiment of the disclosure.

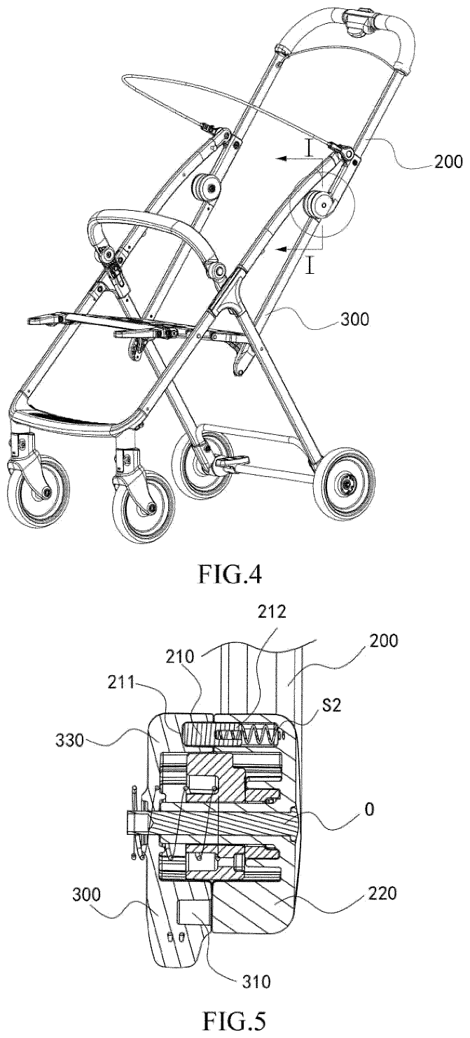

Referring to FIG. 5, in the second embodiment, the ends of the first and second rods are connected by a connecting shaft O, so that the first and second rods are rotatable with respect to each other around the connecting shaft O.

As shown in FIG. 5, the first rod is the lower handle frame 300 of the frame 1, and the second rod is the upper handle frame 200 of the frame 1. An upper end 330 of the lower handle frame 300 and a lower end 220 of the upper handle frame 200 are hinged together by a connecting shaft O.

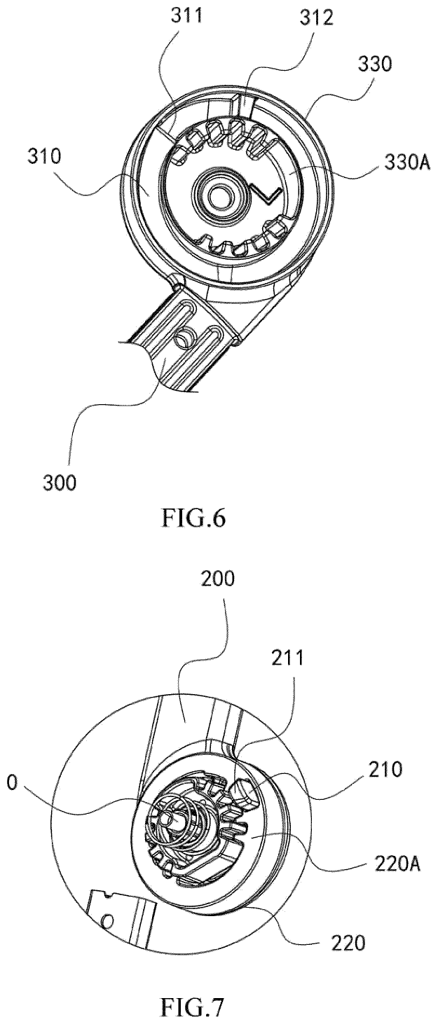

In order to realize the function of the frame 1 for assisting folding or unfolding of the pushcart, the auxiliary mechanism according to the second embodiment further includes: an inclined chute 310 that is in an annular shape and located at a first coupling end face 330A of an upper end 330 of the lower handle frame 300 and around the connecting shaft O. The inclined chute 310 is inclined along the rotation direction (i.e., the circumferential direction of first coupling end face 330A) and has a highest point 311, as shown in FIG. 6. The auxiliary mechanism includes a driving block 210 disposed on a second coupling end face 220A of a lower end of 220 of the upper handle frame 200. The driving block 210 is arranged to be able to extend out of or retract from the second coupling end face 220A, and a top end 211 of the driving block 210 slides while abutting against the inclined chute 310, as shown in FIG. 7.

Preferably, the top end 211 of the driving block 210 can be arranged to have an arc-shaped top surface, so as to reduce the friction force of the top end 211 in sliding while abutting against the inclined chute 310.

In the second embodiment, the elastic member is a compression spring S2 disposed inside the lower end 220 of the upper handle frame 200. The compression spring S2 acts on a bottom end 212 of the driving block 210, as shown in FIG. 5, so as to force the driving block 210 to extend out of the second coupling end face 220A and press against the inclined chute 310.

In the second embodiment, the driving block 210 exerts an acting force on the inclined chute 310 under the acting force of the compression spring S2, and the inclined chute 310 in turn exerts a reaction force on the driving block 210. Since the surface of the inclined chute 310 is inclined with respect to the acting force direction of the driving block 210 (i.e., the extending direction of the driving block 210), the reaction force exerted by the inclined chute 310 on the driving block 210 will generate a force component along the rotating direction, which makes the driving block 210 slide down along the inclined chute 310 under the reaction force of the inclined chute 310, so as to bring the lower end 220 of the upper handle frame 200 to rotate with respect to the upper end 330 of the lower handle frame 300, thereby realizing the relative pivoting of the upper handle frame 200 and the lower handle frame 300.

Preferably, the inclined chute 310 is provided with a blocking portion 312 to block the driving block 210 at the blocking portion 312, such that the lower end 220 of the upper handle frame 200 can rotate only within a certain angle in one direction with respect to the upper end 330 of the lower handle frame 300. The purpose of arranging the blocking portion 312 is that when the upper handle frame 200 and the lower handle frame 300 are relatively pivoted to a first position, the frame 1 reaches the unfolded state. At this time, if the lower end 220 of the upper handle frame 200 can continue to rotate in this direction with respect to the upper end 330 of the lower handle frame 300, i.e., if the upper handle frame 200 and the lower handle frame 300 can be continuously pivoted relative to each other, the frame 1 will be in an unstable unfolded state, which will lead to potential safety hazards. If the inclined chute 310 is provided with the blocking portion 312, since the driving block 210 is blocked at the blocking portion 312, the lower end 220 of the upper handle frame 200 can only rotate to a certain angle in one direction with respect to the upper end 330 of the lower handle frame 300, such that the upper handle frame 200 and the lower handle frame 300 are prevented from being further relatively pivoted when they are relatively pivoted to the first position, thus avoiding potential safety hazards.

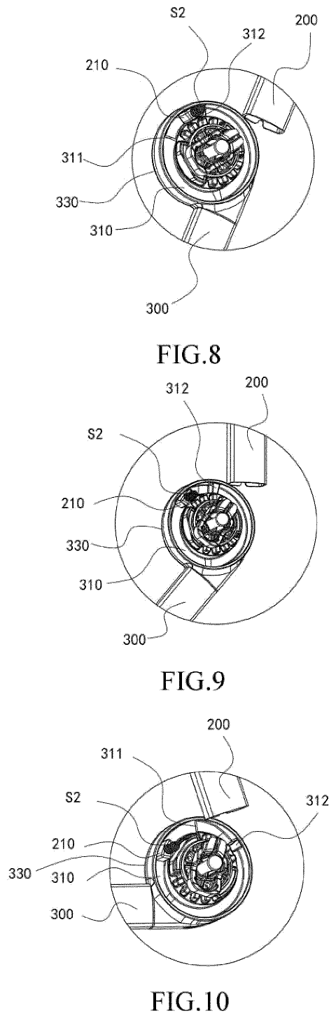

Next, an operation state of the auxiliary mechanism according to the second embodiment of the disclosure will be described with reference to FIGS. 8 to 10.

As shown in FIG. 8, the driving block 210 disposed at the lower end 220 of the upper handle frame 200 is blocked by the blocking portion 312 on the inclined chute 310. At this time, the upper handle frame 200 and the lower handle frame 300 are relatively pivoted to the first position, and the frame 1 is in the unfolded state. At the same time, the driving block 210 continuously abuts against the blocking portion 312 along the inclined chute 310 under the acting force of the compression spring S2, such that the upper handle frame 200 and the lower handle frame 300 are kept in the first position, and the frame 1 is kept in the unfolded state.

When the user is ready to fold the frame 1, the user can exert an acting force on the frame 1 so that the upper handle frame 200 and the lower handle frame 300 are relatively pivoted from the first position to the second position, thereby overcoming the elastic force of the compression spring S2 to cause the driving block 210 to slide up along the inclined chute 310 until the driving block 210 reaches the highest point 311 of the inclined chute 310, as shown in FIG. 9 (the highest point 311 is not shown in FIG. 9 because it is covered by the driving block 210). At this time, the compression spring S2 is compressed to minimum, and the elastic force exerted by the compression spring S2 on the driving block 210 also reaches maximum. Then, after the upper handle frame 200 and the lower handle frame 300 are continuously relatively pivoted towards the second position, such that the driving block 210 crosses the highest point 311, the user does not need to exert any acting force on the frame 1, and the elastic force of the compression spring S2 can force the driving block 210 to slide down along the inclined chute 310, thus bringing the lower end 220 of the upper handle frame 200 to rotate with respect to the upper end 330 of the lower handle frame 300. As such, the upper handle frame 200 and the lower handle frame 300 are allowed to continuously relatively pivoted towards the second position, as shown in FIG. 10, until the upper handle frame 200 and the lower handle frame 300 are relatively pivoted to the second position and remain in the second position.

When the user is ready to unfold the frame 1, the process is opposite to folding the frame 1.

Therefore, by the arrangement of the auxiliary mechanism according to the second embodiment of the disclosure, the compression spring S2 can drive the upper handle frame 200 and the lower handle frame 300 to be relatively pivoted towards the first position, and can also drive the upper handle frame 200 and the lower handle frame 300 to be relatively pivoted towards the second position.

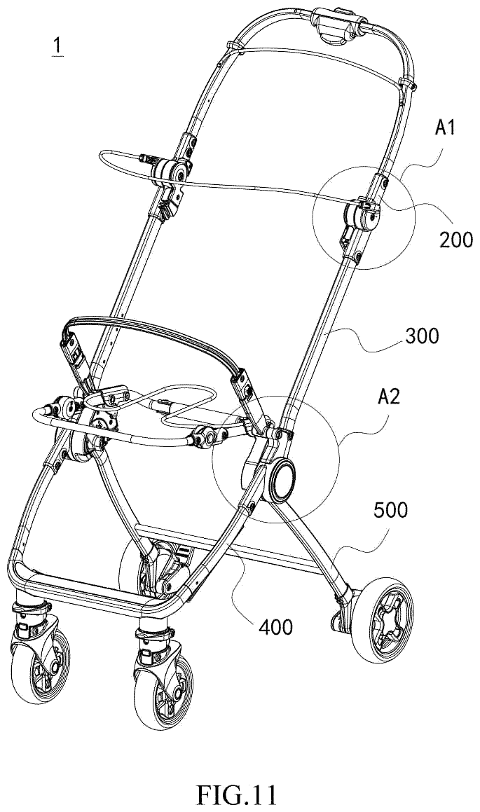

FIGS. 11 to 14 show the auxiliary mechanism according to a third embodiment of the disclosure.

In the third embodiment, an end of the first rod and an end of the second rod are also coupled by a connecting shaft to be relatively rotatable around the connecting shaft.

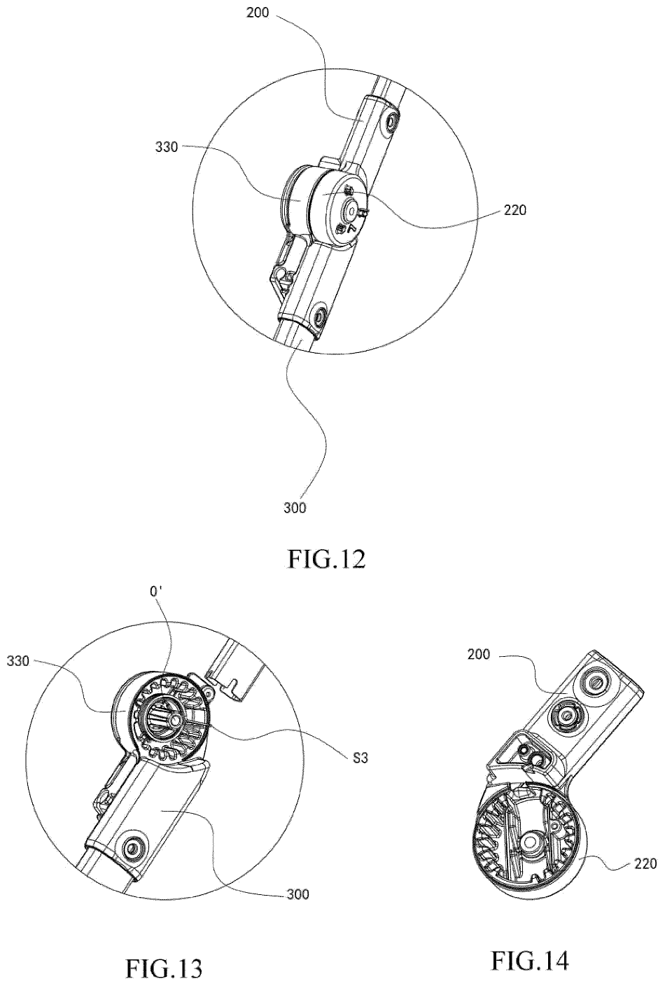

As shown in FIGS. 11 and 12, the first rod is the lower handle frame 300 of the frame 1, and the second rod is the upper handle frame 200 of the frame 1. The upper end 330 of the lower handle frame 300 and the lower end 220 of the upper handle frame 200 are hinged together by a connecting shaft O′ (see FIG. 13).

In the third embodiment, the elastic member is a torsion spring S3 arranged around the connecting shaft O′. One end of the torsion spring S3 is connected to the lower end 220 of the upper handle frame 200, and the second end of the torsion spring S3 is connected to the upper end 330 of the lower handle frame 300, such that the torsion spring S3 can drive the lower end 220 of the upper handle frame 200 and the upper end 330 of the lower handle frame 300 to rotate with respect to each other, such that the upper handle frame 200 and the lower handle frame 300 are relatively pivoted towards one of the first position or the second position.

For example, referring to FIG. 13, when the frame is in the unfolded state, the torsion spring S3 is in a stressed state. When the user is ready to fold the frame, the user can release the lock on the frame in the unfolded state, so that the torsion spring S3 can drive the lower end 220 of the upper handle frame 200 and the upper end 330 of the lower handle frame 300 to rotate with respect to each other, and the upper handle frame 200 and the lower handle frame 300 are relatively pivoted towards the second position, thus realizing automatic folding of the frame.

Of course, the torsion spring S3 can also be arranged to be in the stressed state when the frame is in the folded state. In such case, when the user is ready to unfold the frame, the user can release the lock on the frame in the folded state, and the torsion spring S3 release the lock on the lower end 220 of the upper handle frame 200 and the upper end 330 of the lower handle frame 300 to rotate with respect to each other, such that the upper handle frame 200 and the lower handle frame 300 are relatively pivoted towards the first position, thereby realizing automatic unfolding of the frame.

Different from the first and second embodiments, in the auxiliary mechanism according to the third embodiment of the disclosure, the torsion spring S3 is allowed to only drive the upper handle frame 200 and the lower handle frame 300 to be relatively pivoted towards one of the first position or the second position.

In addition, two ends of the torsion spring S3 can be connected to the lower end 220 of the upper handle frame 200 and the upper end 330 of the lower handle frame 300 in various ways. For example, holes may be formed respectively in the lower end 220 of the upper handle frame 200 and the upper end 330 of the lower handle frame 300, and then two ends of the torsion spring S3 can be inserted into the corresponding holes. Alternatively, fixing posts may be disposed respectively in the lower end 220 of the upper handle frame 200 and the upper end 330 of the lower handle frame 300, and then two ends of the torsion spring S3 may be coupled to the corresponding fixing posts.

FIGS. 11 and 15 to 17 show the auxiliary mechanism according to a fourth embodiment of the disclosure.

In the fourth embodiment, an end of the first rod and an end of the second rod are also coupled by a connecting shaft to be relatively rotatable around the connecting shaft to rotate with respect to each other.

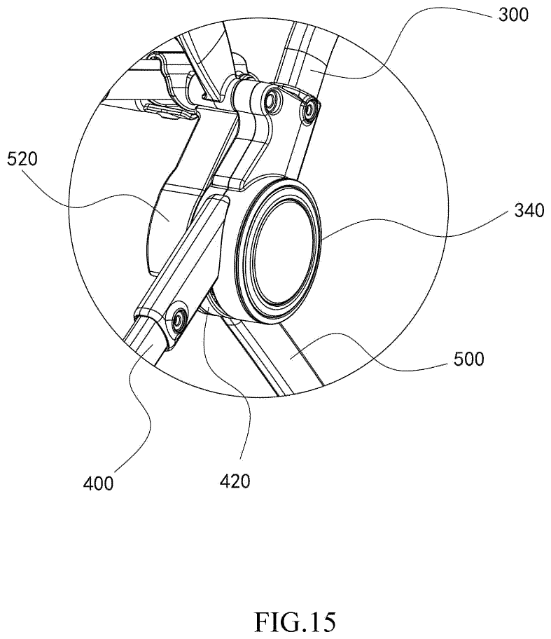

As shown in FIGS. 11 and 15, the first rod is the lower handle frame 300 of the frame 1, and the second rod is the front wheel bracket 400 of the frame 1. The lower end 340 of the lower handle frame 300 and the upper end 420 of the front wheel bracket 400 are hinged together by a connecting shaft O″.

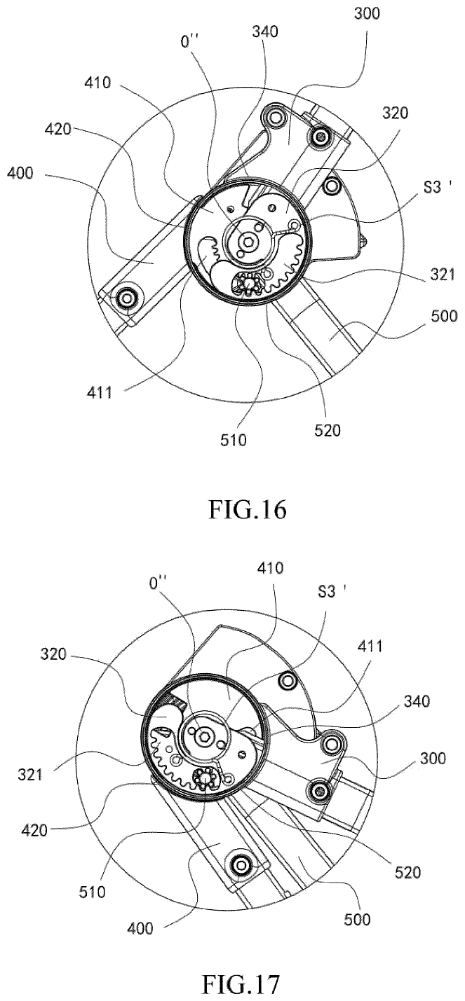

In the fourth embodiment, the elastic member is a torsion spring S3′ arranged around the connecting shaft O″. However, different from the third embodiment, as shown in FIGS. 16 and 17, a coupling end face of the lower end 340 of the lower handle frame 300 is fixed to a first sheet member 320, and a coupling end face of the upper end 420 of the front wheel bracket 400 is fixed to a second sheet member 410. One end of the torsion spring S3′ is connected to the first sheet member 320, and the other end is connected to the second sheet member 410, so the torsion spring S3′ can drive the lower end 340 of the lower handle frame 300 and the upper end 420 of the front wheel bracket 400 to rotate with respect to each other, such that the lower handle frame 300 and the front wheel bracket 400 are relatively pivoted towards one of the first position or the second position.

In a scheme of the fourth embodiment, the upper end 520 of the rear wheel bracket 500 is coupled to the lower end 340 of the lower handle frame 300 and the upper end 420 of the front wheel bracket 400 by a connecting shaft O″, such that both the lower handle frame 300 and the front wheel bracket 400 can be pivoted with respect to the rear wheel bracket 500.

In order to realize a synchronous reverse pivoting of the lower handle frame 300 and the front wheel bracket 400 with respect to the rear wheel bracket 500, as shown in FIGS. 16 and 17, the first sheet member 320 is provided with a first bending slot 321 penetrating the first sheet member 320 and extending around the connecting shaft O″, and the second sheet member 410 is provided with a second bending slot 411 penetrating the second sheet member 410 and extending around the connecting shaft O″. The second bending slot 411 and the first bending slot 321 have corresponding radial positions with respect to the connecting shaft O″. Moreover, the first bending slot 321 and the second bending slot 411 are arranged to have overlapping portions. The upper end 520 of the rear wheel bracket 500 is fixed with a self-rotating linkage gear 510, and the linkage gear 510 is arranged to penetrate into the overlapping portions.

Moreover, each of the first bending slot 321 and the second bending slot 411 has a rack structure engaged with the linkage gear 510, such that a rotation of the first bending slot 321 can bring the second bending slot 411 to rotate synchronously and reversely with the aid of the linkage gear 510. As such, the first sheet member 320 where the first bending slot 321 is located and the second sheet member 410 where the second bending slot 411 is located ′ in turn rotate synchronously and reversely around the connecting shaft O′, i.e., the lower end 340 of the lower handle frame 300 and the upper end 420 of the front wheel bracket 400 rotate synchronously and reversely, such that the lower handle frame 300 and the front wheel bracket 400 are pivoted synchronously and reversely with respect to the rear wheel bracket 500. In the example shown in FIGS. 16 and 17, the rack structure of the first bending slot 321 is arranged on an outer side of the first bending slot 321 away from the connecting shaft O″, and the rack structure of the second bending slot 411 is arranged on an inner side of the second bending slot 411 close to the connecting shaft O″, so as to ensure that the first bending slot 321 and the second bending slot 411 with the aid of the linkage gear 510 rotate reversely with respect to each other, thereby ensuring the lower handle frame 300 and the front wheel bracket 400 being pivoted reversely with respect to the rear wheel bracket 500. Of course, the disclosure is not limited to this. For example, the rack structure of the first bending slot 321 may be arranged at the inner side of the first bending slot 321 close to the connecting shaft O″, and the rack structure of the second bending slot 411 may be arranged on the outer side of the second bending slot 411 away from the connecting shaft O″, which can achieve the same effect. Here, “synchronously|” means that the related rotating or pivoting is performed in the same angle and speed.

The working process of this scheme will be described in detail below.

Referring to FIG. 16, at this time, the frame is in the unfolded state, the torsion spring S3′ is in the stressed state, and the linkage gear 510 is located in the overlapping portions of the front end of the first bending slot 321 and the rear end of the second bending slot 411. When the user is ready to fold the frame 1, the user may release the lock on the frame in the unfolded state, and the torsion spring S3′ will drive the first sheet member 320 and the second sheet member 410 to rotate reversely around the connecting shaft O″, such that the lower end 340 of the lower handle frame 300 and the upper end 420 of the front wheel bracket 400 to rotate with respect to each other, and finally causing the lower handle frame 300 and the front wheel bracket 400 to be relatively pivoted respect to the rear wheel bracket 500 towards the second position. During this process, the lower end 340 of the lower handle frame 300 rotates with respect to the upper end 520 of the rear wheel bracket 500, and at this time, the first sheet member 320 located at the lower end 340 of the lower handle frame 300, together with the first bending slot 321 located on the first sheet member 320, rotate around the connecting shaft O″. Since the rack structures of both the first bending slot 321 and the second bending slot 411 are engaged with the linkage gear 510, during the rotation of the first bending slot 321, the rack structure of the first bending slot 321 drives the linkage gear 510 to rotate itself, and the rotating linkage gear 510 drives the second bending slot 411 and the second sheet member 410 where it is located to rotate reversely around the connecting shaft O″ via the rack structure of the second bending slot 411, such that the upper end 420 of the front wheel bracket 400 rotates reversely with respect to the upper end 520 of the rear wheel bracket 500. As a result, the lower handle frame 300 and the front wheel bracket 400 are pivoted synchronously and reversely with respect to the rear wheel bracket 500, thereby realizing the automatic folding of the frame, as shown in FIG. 17.

Of course, when the frame is in the folded state shown in FIG. 17, the torsion spring S3′ may also be arranged to be in the stressed state. In such case, when the user is ready to unfold the frame, the user may release the lock on the frame in the folded state, the torsion spring S3′ drives the first sheet member 320 and the second sheet member 410 to rotate with respect to each other around the connecting shaft O″, such that the lower end 340 of the lower handle frame 300 and the upper end 420 of the front wheel bracket 400 to rotate with respect to each other, and finally causing the lower handle frame 300 and the front wheel bracket 400 to be relatively pivoted towards the first position. The latter process is opposite to the above process of folding the frame.

As mentioned above, by the auxiliary mechanism according to the disclosure, it is possible to facilitate folding or unfolding of the frame of the pushcart, thereby making the use of the pushcart more convenient and reliable.

Since the features of the disclosure can be embodied in various forms without departing from the characteristics of the disclosure, it should also be understood, the above embodiments are not limited to any details described above, unless otherwise indicated, but should be broadly interpreted as being within the scope defined by the appended claims. Therefore, all modifications and alterations that fall within the scope and limits of the claims or the equivalent of such scope and limits should be covered by the appended claims.

### LIST OF REFERENCE SIGNS

1 FRAME
100 SUPPORT FRAME
200 UPPER HANDLE FRAME
   210 DRIVING BLOCK
      211 TOP END
      212 BOTTOM END
   220 LOWER END OF UPPER HANDLE FRAME
      220A SECOND COUPLING END FACE
300 LOWER HANDLE FRAME
   310 INCLINED CHUTE
      311 HIGHEST POINT
      312 BLOCKING PORTION
   320 FIRST SHEET MEMBER
      321 FIRST BENDING SLOT
   330 UPPER END OF LOWER HANDLE FRAME
      330A FIRST COUPLING END FACE
   340 LOWER END OF LOWER HANDLE FRAME
400 FRONT WHEEL BRACKET
   410 SECOND SHEET MEMBER
      411 SECOND BENDING SLOT
   420 UPPER END OF FRONT WHEEL BRACKET
500 REAR WHEEL BRACKET
   510 LINKAGE GEAR
   520 UPPER END OF REAR WHEEL BRACKET
S1 TENSION SPRING
S2 COMPRESSION SPRING
S3, S3′ TORSION SPRING
L1, L2, L3 TENSION SPRING'S STRETCHED LENGTH
O, O′, O″ CONNECTING SHAFT

1. An auxiliary mechanism for assisting folding or unfolding a frame of a pushcart, wherein the frame includes a first rod and a second rod being pivotable relative to each other, and when the first rod and the second rod are relatively pivoted to a first position, the frame is in an unfolded state; and when the first rod and the second rod are relatively pivoted to a second position, the frame is in a folded state,
wherein the auxiliary mechanism comprises an elastic member, and the elastic member drives the first rod and the second rod to be relatively pivoted towards the first position or towards the second position.

2. The auxiliary mechanism according to claim 1, wherein the first rod is a support frame of the frame, and the second rod is an upper handle frame of the frame, wherein an end of the support frame is hinged to the upper handle frame, the elastic member is a tension spring, one end of the tension spring is connected to the support frame, and the other end of the tension spring is connected to the upper handle frame, such that when the support frame and the upper handle frame are relatively pivoted to the first position or the second position, a stretched length of the tension spring is smaller than a maximum length of the tension spring being stretched when the support frame and the upper handle frame are relatively pivoted.

3. The auxiliary mechanism according to claim 1, wherein an end of the first rod and an end of the second rod are coupled by a connecting shaft, so that the first rod and the second rod are rotatable with respect to each other around the connecting shaft.

4. The auxiliary mechanism according to claim 3, wherein the first rod is a lower handle frame of the frame, and the second rod is an upper handle frame of the frame,
wherein the auxiliary mechanism further comprises:
an inclined chute in an annular shape, located at a first coupling end face of an upper end of the lower handle frame and around the connecting shaft, and the inclined chute being inclined along a rotation direction and has a highest point;
a driving block, disposed on a second coupling end face of a lower end of the upper handle frame, the driving block being able to extend out of or retract from the second coupling end face, and a top end of the driving block slides while abutting against the inclined chute; and
wherein the elastic member is a compression spring disposed inside a lower end of the upper handle frame, the compression spring acts on a bottom end of the driving block, so as to drive the driving block to extend out of the second coupling end face and press against the inclined chute, and the driving block slides along the inclined chute, so as to bring the lower end of the upper handle frame to rotate with respect to the upper end of the lower handle frame.

5. The auxiliary mechanism according to claim 4, wherein the inclined chute is provided with a blocking portion to block the driving block at the blocking portion, such that the lower end of the upper handle frame is able to rotate within a certain angle in one direction with respect to the upper end of the lower handle frame.

6. The auxiliary mechanism according to claim 3, wherein the first rod is a lower handle frame of the frame, and the second rod is an upper handle frame of the frame, and
the elastic member is a torsion spring arranged around the connecting shaft, wherein one end of the torsion spring is connected to a lower end of the upper handle frame, and the other end of the torsion spring is connected to an upper end of the lower handle frame, so that the torsion spring is able to drive the lower end of the upper handle frame and the upper end of the lower handle frame to rotate with respect to each other, and the upper handle frame and the lower handle frame are relatively pivoted towards one of the first position or the second position.

7. The auxiliary mechanism according to claim 3, wherein:
the first rod is a lower handle frame of the frame, the second rod is a front wheel bracket of the frame, and the elastic member is a torsion spring arranged around the connecting shaft,
a coupling end face of a lower end of the lower handle frame is fixed to a first sheet member, and the coupling end face of an upper end of the front wheel bracket is fixed to a second sheet member, and
one end of the torsion spring is connected to the first sheet member, and the other end of the torsion spring is connected to the second sheet member, so that the torsion spring is able to drive the lower end of the lower handle frame and the upper end of the front wheel bracket to rotate with respect to each other, and the lower handle frame and the front wheel bracket are relatively pivoted towards one of the first position or the second position.

8. The auxiliary mechanism according to claim 7, wherein an upper end of a rear wheel bracket of the frame is coupled to the lower end of the lower handle frame and the upper end of the front wheel bracket by the connecting shaft, such that the lower handle frame and the front wheel bracket are able to be pivoted with respect to the rear wheel bracket.

9. The auxiliary mechanism according to claim 8, wherein:
the first sheet member is provided with a first bending slot penetrating the first sheet member and extending around the connecting shaft, and the second sheet member is provided with a second bending slot penetrating the second sheet member and extending around the connecting shaft, wherein the second bending slot and the first bending slot have corresponding radial positions with respect to the connecting shaft, and the first bending slot and the second bending slot are arranged to have overlapping portions,
the upper end of the rear wheel bracket is fixed with a linkage gear, and the linkage gear is arranged to penetrate into the overlapping portions; and
wherein each of the first bending slot and the second bending slot has a rack structure engaged with the linkage gear, when the first bending slot of the first sheet member rotates around the connecting shaft, the rack structure of the first bending slot drives the linkage gear, and the linkage gear drives the second bending slot of the second sheet member to rotate reversely around the connecting shaft via the rack structure of the second bending slot, such that the first sheet member and the second sheet member rotate synchronously and reversely around the connecting shaft.

10. A pushcart, comprising a frame and the auxiliary mechanism according to claim 1, wherein the frame is assisted to be folded or unfolded by the auxiliary mechanism.

11. The auxiliary mechanism according to claim 2, wherein an end of the first rod and an end of the second rod are coupled by a connecting shaft, so that the first rod and the second rod are rotatable with respect to each other around the connecting shaft.

12. The auxiliary mechanism according to claim 7, wherein:
the first sheet member is provided with a first bending slot penetrating the first sheet member and extending around the connecting shaft, and the second sheet member is provided with a second bending slot penetrating the second sheet member and extending around the connecting shaft, wherein the second bending slot and the first bending slot have corresponding radial positions with respect to the connecting shaft, and the first bending slot and the second bending slot are arranged to have overlapping portions,
an upper end of a rear wheel bracket of the frame is fixed with a linkage gear, and the linkage gear is arranged to penetrate into the overlapping portions; and
wherein each of the first bending slot and the second bending slot has a rack structure engaged with the linkage gear, when the first bending slot of the first sheet member rotates around the connecting shaft, the rack structure of the first bending slot drives the linkage gear, and the linkage gear drives the second bending slot of the second sheet member to rotate reversely around the connecting shaft via the rack structure of the second bending slot, such that the first sheet member and the second sheet member rotate synchronously and reversely around the connecting shaft.

13. A pushcart, comprising a frame and the auxiliary mechanism according to claim 2, wherein the frame is assisted to be folded or unfolded by the auxiliary mechanism.

14. A pushcart, comprising a frame and the auxiliary mechanism according to claim 3, wherein the frame is assisted to be folded or unfolded by the auxiliary mechanism.

15. A pushcart, comprising a frame and the auxiliary mechanism according to claim 4, wherein the frame is assisted to be folded or unfolded by the auxiliary mechanism.

16. A pushcart, comprising a frame and the auxiliary mechanism according to claim 5, wherein the frame is assisted to be folded or unfolded by the auxiliary mechanism.

17. A pushcart, comprising a frame and the auxiliary mechanism according to claim 6, wherein the frame is assisted to be folded or unfolded by the auxiliary mechanism.

18. A pushcart, comprising a frame and the auxiliary mechanism according to claim 7, wherein the frame is assisted to be folded or unfolded by the auxiliary mechanism.

19. A pushcart, comprising a frame and the auxiliary mechanism according to claim 8, wherein the frame is assisted to be folded or unfolded by the auxiliary mechanism.

20. A pushcart, comprising a frame and the auxiliary mechanism according to claim 9, wherein the frame is assisted to be folded or unfolded by the auxiliary mechanism.
